(19) United States
(12) Patent Application Publication
(10) Pub. No.: US 2012/0097262 A1
(43) Pub. Date: Apr. 26, 2012

(54) HOSE EVACUATION ATTACHMENT AND METHOD OF USE

(76) Inventor: Gary Piecuch, Catonsville, MD (US)

(21) Appl. No.: 12/910,835

(22) Filed: Oct. 24, 2010

(51) Int. Cl. B08B 9/02

(52) U.S. Cl. 137/15.04; 15/406

(57) ABSTRACT

The present invention discloses a hose evacuation attachment comprising a conical body, an accepting end at a first end of the conical body, and a narrowed opening at an opposing end from the accepting end, where the narrowed opening includes a smaller diameter than the accepting end. The hose evacuation attachment further includes a threaded neck extending from the narrowed opening, wherein the threaded neck fastens to a fitting at an end of a hose, and wherein the accepting end attaches to an end of an elongated tube of an air blower. Once attached the hose evacuation attachment serves as an intermediary to enable the air blower to evacuate an amount of water remaining within the hose.

### BACKGROUND OF THE INVENTION

1. Field of the Invention

The present invention relates to a connection device to enable a leaf blower to evacuate the water accumulated within a hose to prepare the hose for storage.

2. Description of Related Art

Individuals living in states that experience cold winters know the importance of winterizing their pipes and hoses to prepare for the freezing temperatures associated with winter. Winterizing involves draining water from the pipes and hoses of a home, sprinkler system or recreational vehicle. When water cools and eventually freezes it expands in volume, whereas when a pipe or hose cools and freezes they become stiff and rigid. During winterizing all of the water must be cleared otherwise the internal pressure of the expanding water causes damage to the pipes and hoses. The water pressure may become so great against the rigid pipes and hoses that they may crack or even burst in cold temperatures.

A conventional method of clearing a garden hose is to simply detach the hose from the spout and hang it from an end to allow gravity to clear the water. This method is simple but may be burdensome finding a tall object from where to hang the hose. Alternatively, the user may move along the hose, repeatedly raising their arm and lifting the hose to clear the water. The second method is tiring to the user because of all the physical labor.

Prior art 3845779 discloses a garden hose evacuating device wherein an attachment is connected to the water faucet and then attached to the hose. The garden hose evacuation device includes a fitting to accept an air or gas blowing device. The water is evacuated when the air or gas blowing device is activated thus blowing the water from the garden hose. This device is useful but it requires attaching the garden hose evacuation device to the faucet.

It would be beneficial in the art to provide a device which enables a user to clear a hose by simply attaching the hose to a blowing device.

### SUMMARY OF THE INVENTION

An object of the present invention is to provide a device which attaches between a hose and an air blower to enable the air blower to evacuate the water accumulated in the hose in order to prepare the hose for storage.

In view of the foregoing disadvantages inherent in the prior art, the general purpose of the present disclosure is to provide a hose evacuation attachment comprising a conical body, an accepting end at a first end of the conical body, and a narrowed opening at an opposing end from the accepting end, where the narrowed opening includes a smaller diameter than the accepting end. The hose evacuation attachment further includes a threaded neck extending from the narrowed opening, wherein the threaded neck fastens to a fitting at an end of a hose, and wherein the accepting end attaches to an end of an elongated tube of an air blower. Once attached the hose evacuation attachment serves as an intermediary to enable the air blower to evacuate an amount of water remaining within the hose.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a hose evacuation attachment in accordance with an exemplary embodiment of the present invention; and

FIG. 2 depicts a perspective view of a hose storage container in accordance with an exemplary embodiment of the present invention.

Like reference numerals refer to like parts throughout the description of several views of the drawings.

### DETAILED DESCRIPTION OF THE DRAWINGS

The present invention relates to a connection device to enable a leaf blower to evacuate the water accumulated within a hose to prepare the hose for storage. The present invention is a hose evacuation attachment which enables a user to conveniently clear the interior of a garden hose for storage during the winter months. The hose evacuation attachment screws onto an end of the garden hose and then is affixed to a leaf blower. Once the blower is activated, a gust of air creates pressure which forces the water out of an opposite end of the hose. After the water is cleared, the hose may be stored for the winter. The hose evacuation attachment may save the user money by preventing water damage thus alleviating the necessity of buying replacement hoses.

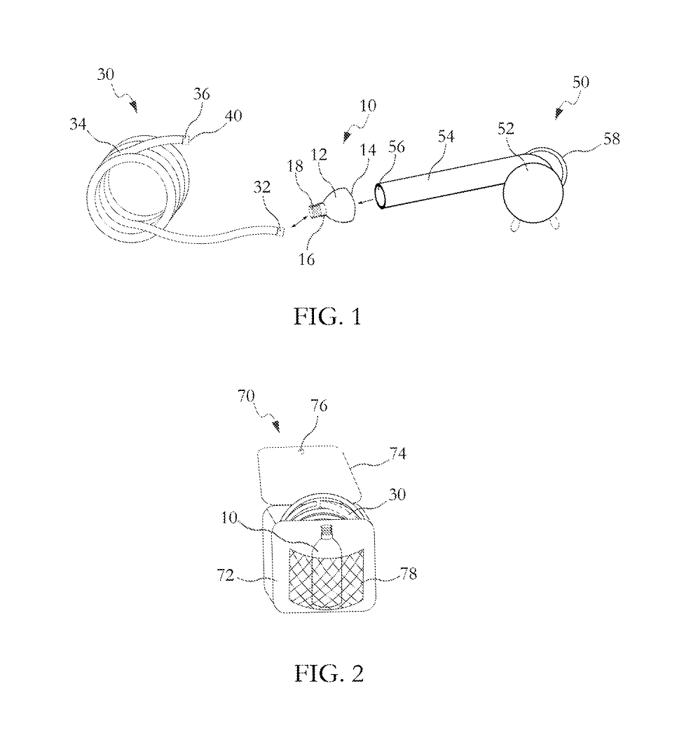

Turning now descriptively to the drawings, referring to FIG. 1, a perspective view of a hose evacuation attachment (10) is shown in accordance with an exemplary embodiment of the present invention. The hose evacuation attachment (10) may comprise a conical body (12) which includes a first end or an accepting end (14), and then gradually tapers to a narrow opening (16). The narrow opening (16) may include a threaded neck (18) extending from the conical body (12).

Generally, the hose evacuation attachment (10) serves as an intermediary to connect a hose (30) to a leaf blower (50) or an alternative air blower like a shop vacuum (not shown). At an end of the hose (30) may be a fitting (32) to attach to the threaded neck (18) of the hose evacuation device (10). The hose (30) may stretch in an elongated form or be wrapped to include a coiled portion (34). The leaf blower (50) includes a motor (52), an elongated tube (54) and a handle (58). The accepting end (14) of the hose evacuation attachment (10) may secure around a tube end (56) of the elongated tube (54).

The conical body (12) may be composed of a sturdy plastic or hard rubber material, strong enough to withstand creating a tight attachment between the hose (30) and the leaf blower (50). Accordingly, the conical body (12) may have a length which extends up to approximately 12 inches to accept a greater portion of the elongated tube (54) rather than merely the tube end (56). By fitting more of the elongated tube (54) into the conical body (12) the more secure the fit may be between the leaf blower (50) and the hose (30).

Referring now to FIG. 2, a perspective view of a hose storage container (70) is shown in accordance with an exemplary embodiment of the present invention. The hose storage container (70) may include a bottom compartment (72) and a lid (74). After the hose (30) is flushed it is coiled and placed into bottom compartment (72). The lid (74) may be secured to the bottom compartment (72) with a securing means (76) which may be a zipper, a magnet, a clip or a lock. The hose storage container (70) may include a pocket (78) to hold the hose evacuation attachment (10). The pocket (78) may be an elastic mesh pocket or a zipper pocket which stretches to accept the hose evacuation attachment (10). The pocket (78) may ensure that the user never misplaces or loses the hose evacuation attachment (10) by always keeping it with the hose (30). The hose storage container (70), the hose (30) and the hose evacuation attachment (10) may all be stored together in a garage, storage shed or closet until the hose (30) is need again.

To use the hose evacuation attachment (10) the user first fastens the threaded neck (18) to the fitting (32) on the hose (30). Next, the user attaches the accepting end (14) to the tube end (56) of the leaf blower (50). Once the hose evacuation attachment (10) is connected between the hose (30) and the leaf blower (50), the leaf blower (50) is activated to blow a gust of air at high pressure. The gust of air evacuates an amount of water (40) remaining within the hose (30) out of an opposing end (36) from the fitting (32). After the amount of water (40) is cleared, the hose evacuation attachment (10) is detached and the hose (30) may be wrapped and stored until needed again for use. By allowing the user to conveniently clear and store the hose (30), ensures a greater lifespan of the hose (30) thus saving money by not having to buy replacement hoses.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A hose evacuation attachment comprising:
a conical body;
an accepting end at a first end of said conical body;
a narrowed opening at an opposing end from said accepting end, where said narrowed opening includes a smaller diameter than said accepting end; and
a threaded neck extending from said narrowed opening,
wherein said threaded neck fastens to a fitting at an end of a hose, and
wherein said accepting end attaches to an end of an elongated tube of an air blower.

2. The hose evacuation attachment of claim 1, wherein said air blower is a leaf blower.

3. The hose evacuation attachment of claim 1, wherein said air blower is a shop vacuum.

4. The hose evacuation attachment of claim 1, wherein said conical body extends up to a length of 12 inches.

5. The hose evacuation attachment of claim 1, wherein said conical body is made of a sturdy plastic.

6. The hose evacuation attachment of claim 1, wherein said conical body is made of a hard rubber.

7. A method of using a hose evacuation attachment comprising the steps of:
fastening a threaded neck of said hose evacuation attachment to a fitting of a hose;
attaching an accepting end of said hose evacuation attachment to a tube end of an elongated tube of an air blower;
activating said air blower to blow a gust of air through said elongated tube and through said hose evacuation attachment; and
evacuating an amount of water remaining within said hose out of an opposing end of said hose from said fitting.

8. The method of using the hose evacuation device of claim 7 further comprising the step of detaching said hose evacuation device from said hose and from said air blower.

9. The method of using the hose evacuation device of claim 7 further comprising the step of storing said hose evacuation device until needed for later use.
